(19) United States
(12) Patent Application Publication
(10) Pub. No.: US 2026/0086184 A1
(43) Pub. Date: Mar. 26, 2026

(54) SYSTEM FOR DETERMINING THE DIRECTION OF AN ACOUSTIC WAVE

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/895,640

(22) Filed: Sep. 25, 2024

(51) Int. Cl. G01S 3/803; G01S 3/801; H04R 1/28; H04R 1/40

(52) U.S. Cl. CPC G01S 3/8036; G01S 3/801; H04R 1/2811; H04R 1/406

(57) ABSTRACT

Systems for determining the direction of acoustic waves are described herein. In one example, a system for determining the direction of an acoustic wave includes first and second resonator chambers fluidly connected via a channel. The first and second resonator chambers have a speaker configured to output sound based on signals produced from external transducers when detecting the acoustic wave that is acoustically separated from the first and second resonator chambers. The direction of the acoustic wave can be determined based on a comparison of the first acoustic amplitude sensed in the first resonator chamber and the second acoustic amplitude sensed in the second resonator chamber when the speakers output sound.

### TECHNICAL FIELD

The subject matter described herein relates, in general, to systems for determining the direction of an acoustic wave.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Sensing the incident angle of acoustic waves is required for many applications, such as applications involving the localization of a sound source. Systems for sensing acoustic incident angle usually measure the difference in acoustic wave arrival time, or phase difference, at two or more spaced-apart microphones. A significant disadvantage of this approach is that it generally requires a substantial distance between the multiple microphones, making it difficult to use a compact design. Thus, such phase-difference acoustic direction sensing systems are difficult to adapt to applications requiring or benefiting from a small size.

### SUMMARY

This section generally summarizes the disclosure and is not a comprehensive explanation of its full scope or all its features.

In one embodiment, a system for determining the direction of an acoustic wave includes first and second resonator chambers fluidly connected via a channel. The first and second resonator chambers have a speaker configured to output sound based on signals produced from external transducers when detecting the acoustic wave that is acoustically separated from the first and second resonator chambers. The direction of the acoustic wave can be determined based on a comparison of the first acoustic amplitude sensed in the first resonator chamber and the second acoustic amplitude sensed in the second resonator chamber when the speakers output sound.

In another embodiment, a system includes a first resonator having a first resonator chamber and a second resonator having a second resonator chamber, wherein the first resonator chamber is fluidly connected to the second resonator chamber via a channel. A first speaker is connected to the first resonator chamber and is configured to output sound based on a signal produced from a first external transducer when detecting an acoustic wave. A second speaker is connected to the second resonator chamber and is configured to output sound based on a signal produced from a second external transducer when detecting the acoustic wave. In addition, a first internal transducer is configured to sense a first acoustic amplitude of a sound in the first resonator chamber produced by the first and second speakers and a second internal transducer is configured to sense a second acoustic amplitude of a sound in the second resonator chamber produced by the first and second speakers. Like before, the direction of the acoustic wave can be determined based on a comparison of the first acoustic amplitude and the second acoustic amplitude when the speakers output sound.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a system for determining the direction of an acoustic wave.

FIGS. 2A and 2B illustrate cutaway views of different examples of the resonator chambers of the system for determining the direction of an acoustic wave of FIG. 1.

FIG. 3 illustrates a more detailed view of the data acquisition system for use with the system for determining the direction of an acoustic wave of FIG. 1.

FIG. 4A illustrates the acoustic amplitudes of sound in the resonator chambers of FIG. 2A.

FIG. 4B illustrates the ratio of the acoustic amplitudes of FIG. 4A with respect to the direction of the acoustic wave at different frequencies.

FIG. 5A illustrates the acoustic amplitudes of sound in the resonator chambers of FIG. 2B.

FIG. 5B illustrates the ratio of the acoustic amplitudes of FIG. 5A with respect to the direction of the acoustic wave at different frequencies.

### DETAILED DESCRIPTION

Described are systems for determining the angle of an incoming acoustic wave. In one example, a system for determining the direction of an acoustic wave includes first and second resonator chambers fluidly connected via a channel. The first and second resonator chambers have a speaker configured to output sound based on signals produced from external transducers when detecting the acoustic wave that is acoustically separated from the first and second resonator chambers. The direction of the acoustic wave can be determined based on a comparison of the first acoustic amplitude sensed in the first resonator chamber and the second acoustic amplitude sensed in the second resonator chamber when the speakers output sound.

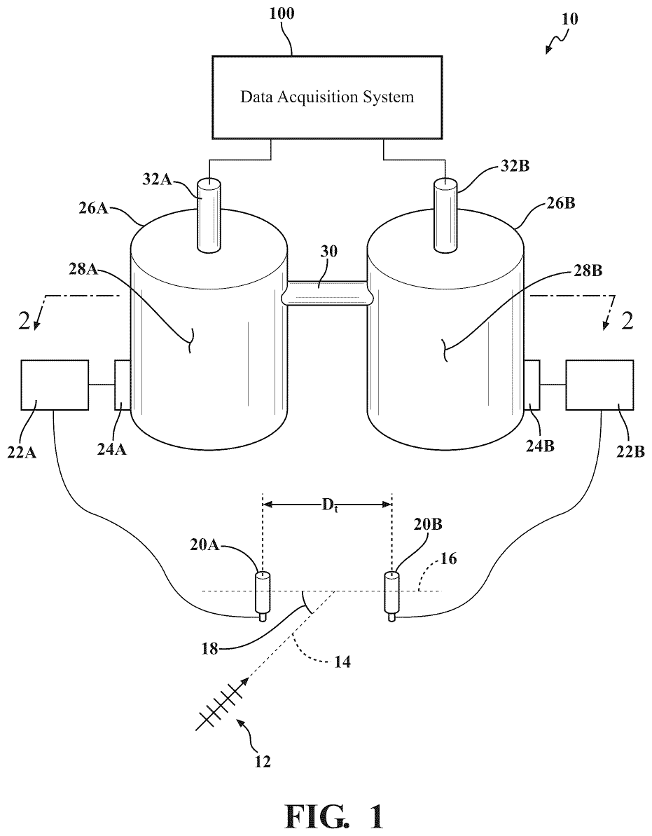

Referring to FIG. 1, illustrated is one example of a system 10 for determining the direction 14 of an acoustic wave 12. It should be understood that the direction 14 of the acoustic wave 12 may be determined relative to the external transducers 20A and 20B, which are generally separated by a known distance Dₜ, which can vary from application to application. Moreover, the direction 14 may be in the form of an incidence angle 18 relative to a line 16 defined between the external transducers 20A and 20B. As will be explained in greater detail later in this description, the direction 14 may be determined in one example by calculating a ratio between two different acoustic amplitudes. Once calculated, the ratio is then utilized along with a mapping that acoustic amplitude ratios to acoustic direction.

The external transducers 20A and 20B may be any device that converts sound energy into electrical signals. Moreover, the external transducers 20A and 20B operate based on the principle of transduction, where one form of energy is transformed into another. As such, the external transducers 20A and 20B may be microphones that convert sound waves into electrical signals. The external transducers 20A and 20B output the signals based on the sound energy of the acoustic wave 12 to speakers 24A and 24B, respectively.

Optionally, the signals outputted by the external transducers 20A and/or 20B may be amplified by amplifiers 22A and/or 22B, respectively, to amplify the signals. Moreover, the amplifiers 22A and/or 22B may boost low-level audio signals, such as those outputted by the external transducers 20A and/or 20B, to a higher level, making them strong enough to drive the speakers 24A and 24B and produce sound. The amplifiers 22A and/or 22B may enhance the power of the audio signals outputted by the external transducers 20A and/or 20B without significantly altering their original quality.

The speakers 24A and 24B are coupled to resonators 26A and 26B, respectively, such that sound output from the speakers 24A and 24B are directed into resonator chambers 28A and 28B. In addition, the resonators 26A and 26B substantially (greater than 90%) acoustically isolate the resonator chambers 28A and 28B from the acoustic wave 12. In some cases, the resonators 26A and 26B may be made of sufficiently appropriate material to achieve this acoustic insulation or may be separated from the acoustic wave 12 such that the acoustic wave 12 is acoustically isolated from the resonator chambers 28A and 28B.

The resonator chambers 28A and 28B are fluidly connected via a channel 30. The channel 30 may be a closed channel such that the interior of the channel 30 is acoustically separated from the acoustic wave 12. As such, the channel 30 allows sound to travel between the resonator chambers 28A and 28B. As such, sound introduced by the speaker 24A into the resonator chamber 28A can travel into the resonator chamber 28B via the channel 30. Similarly, sound introduced by the speaker 24B into the resonator chamber 28B can travel into the resonator chamber 28A via the channel 30.

Also connected to the resonator chambers 28A and 28B are internal transducers 32A and 32B, respectively. The internal transducers 32A and 32B are used to measure the acoustic amplitudes of sound within the resonator chambers 28A and 28B, respectively. As mentioned before, the resonator chambers 28A and 28B are acoustically separated from the acoustic wave 12, and, as such, the internal transducers 32A and 32B may only be measuring the acoustic amplitudes of sound within the resonator chambers 28A and 28B. Similar to the external transducers 20A and 20B, the internal transducers 32A and 32B may be microphones that convert sound waves into electrical signals. The internal transducers 32A and 32B output these electrical signals to the data acquisition system 100. Also, it is worth noting that electrical signals emitted by the internal transducers 32A and 32B may be first amplified or undergo some form of signal processing before or after being received by the data acquisition system 100.

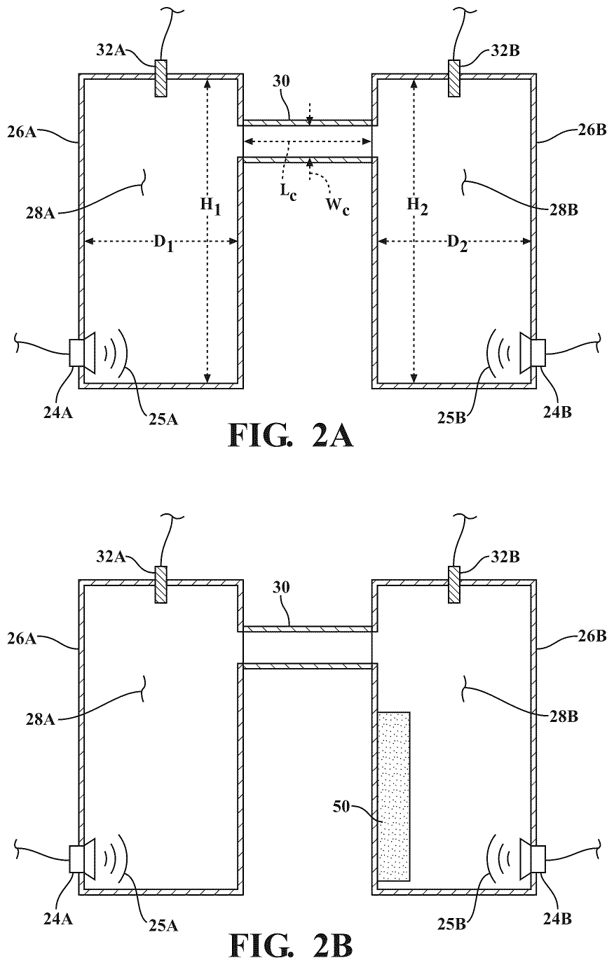

Referring to FIG. 2A, illustrated is a cutaway view generally along lines 2-2 of FIG. 1, illustrating the interior of the resonators 26A and 26B as well as the channel 30. Generally, the resonators 26A and 26B may have approximately the same (i.e., within 25%) resonant frequencies. As such, in one example, the resonator chambers 28A and 28B may have approximately the same (i.e., within 25%) dimensions and/or volumes. For example, the resonator chambers 28A and 28B may be cylindrical in nature and have approximately the same diameters (D₁ and D₂) and similar heights (H₁ and H₂). Of course, it should be understood that the dimensions of the resonator chambers 28A and 28B may vary considerably so long as the resonators 26A and 26B have approximately the same resonant frequencies. In one example, the heights (H₁ and H₂) of the first and second resonator chambers 28A and 28B may be greater than the diameters (D₁ and D₂) of the first and second resonator chambers 28A and 28B by a factor of at least 1.5.

Also shown is the interior of the channel 30. As mentioned before, the channel 30 may be a closed channel that is acoustically isolated from the acoustic wave 12. The channel 30 may take any one of a number of different shapes, such as cylindrical, cuboid, etc. Here, the channel 30 has a length (L_{c}) and a width (W_{c}) that can vary from application to application. Generally, the dimensions of the channel 30 are such that they are large enough to allow acoustic waves to propagate between the resonator chambers 28A and 28B but not so large that they significantly change the acoustic characteristics of the resonators 26A and 26B. In one example, the width (W_{c}) of the channel 30 may be such that it does not exceed 25% of any dimension of the resonator chambers 28A and 28B.

Generally, the position of the speakers 24A and 24B and the internal transducers 32A and 32B within the resonator chambers 28A and 28B can vary from application to application and do not need to be positioned, as shown in the figures. Furthermore, the location of the channel 30 between the resonators 26A and 26B can also vary from application to application and does not need to be positioned as shown in the figures.

Referring to FIG. 2B, a variation of the resonators 26A and 26B is shown. Here, located within the resonator chamber 28B is an acoustic foam 50. The acoustic foam 50 may occupy a portion of one of the resonator 26B. Also, as an alternative, the acoustic foam 50 may be located in the resonator chamber 28A of the resonator 26A. As will be explained later, the acoustic foam 50 can be utilized to reduce multiple resonant peaks.

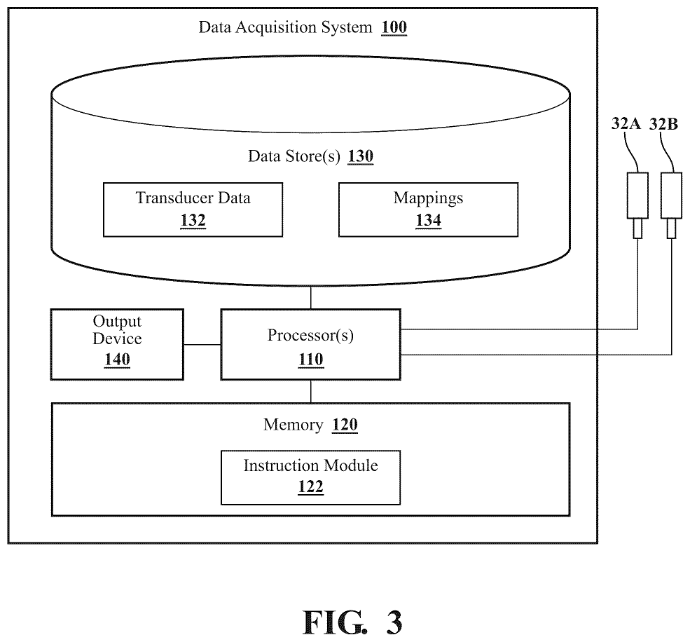

FIG. 3 illustrates a more detailed view of the data acquisition system 100 that will be utilized to determine the angle 18, indicating the direction of the acoustic wave 12, shown in FIG. 1. It should be understood that the data acquisition system 100 is just one example that the data acquisition system 100 may take. As such, the data acquisition system 100 may have more, fewer, or even different components than those illustrated in FIG. 3.

Here, in this example, the data acquisition system 100 includes one or more processor(s) 110. Accordingly, the processor(s) 110 may be a part of the data acquisition system 100, or the data acquisition system 100 may access the processor(s) 110 through a data bus or another communication path. In one or more embodiments, the processor(s) 110 is an application-specific integrated circuit that is configured to implement functions associated with an instruction module 122. In general, the processor(s) 110 is an electronic processor, such as a microprocessor, which is capable of performing various functions as described herein.

The data acquisition system 100 may also include an output device 140 that is in communication with the processor(s) 110. The output device 140 can be any device that is capable of outputting information generated by the data acquisition system 100, such as the angle 18 of the acoustic wave 12. As such, the output device 140 could be a monitor, printer, virtual reality headset, or speaker or could act as a conduit to communicate with other devices (i.e., network access device), either wired or wirelessly.

In one example, the data acquisition system 100 includes a memory 120 that stores instruction module 122. The memory 120 may be a random-access memory (RAM), read-only memory (ROM), a hard disk drive, a flash memory, or other suitable memory for storing the instruction module 122. The instruction module 122 is, for example, computer-readable instructions that, when executed by the processor(s) 110 cause the processor(s) 110 to perform the various functions disclosed herein.

Furthermore, in one example, the data acquisition system 100 includes a data store 130. The data store 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store 130 stores data used by the instruction module 122 in executing various functions.

In this example, the data store 130 may include transducer data 132 collected from the internal transducers 32A and 32B and mappings 134. The transducer data 132 may include any information outputted by internal transducers 32A and 32B or information that is based on that outputted information. As such, this information could include the acoustic amplitudes at one or more frequencies measured by the internal transducers 32A and 32B within the resonator chambers 28A and 28B when sound is provided by the speakers 24A and 24B, respectively. Additionally or alternatively, the transducer data 132 can also include the ratios of the acoustic amplitudes measured by the internal transducers 32A and 32B when sound is provided by the speakers 24A and 24B, respectively.

The mappings 134 may be in the form of a reference table that references a particular ratio to an angle. Moreover, the ratio in the mappings 134 may be the ratio of the acoustic amplitudes measured by the internal transducers 32A and 32B when sound is provided by the speakers 24A and 24B, respectively. The reference table may reference a ratio to an angle, which indicate the angle 18 of the acoustic wave 12. As such, as will be explained in greater detail later, using the mappings 134 and the measurements from the internal transducers 32A and 32B, the angle of the acoustic wave 12 can be determined.

The instruction module 122 contains instructions that cause the processor(s) 110 to perform any of the methodologies described herein. As such, in one example, the instruction module 122 includes instructions that, when executed by the processor(s) 110, cause the processor(s) 110 to receive the transducer data 132. As mentioned before, the transducer data 132 can include the amplitudes measured by the internal transducers 32A and 32B when sound is output by the speakers 24A and 24B, respectively. Sound may be produced by the speakers 24A and 24B in response to the external transducers 20A and 20B outputting signals based on the detection of the acoustic wave 12.

Upon receiving the transducer data 132, the instruction module 122 contains instructions that cause the processor(s) 110 to determine a direction (i.e., the angle 18) of the acoustic wave 12 based on a comparison of the amplitudes measured by the internal transducers 32A and 32B when sound is output by the speakers 24A and 24B, respectively. Moreover, the instruction module 122 may cause the processor(s) 110 to determine a ratio of the amplitudes measured by the internal transducers 32A and 32B when sound is output by the speakers 24A and 24B, respectively. Once the ratio is determined by the processor(s) 110, the instruction module 122 may then cause the processor(s) 110 to utilize the mappings 134 to determine the direction (i.e., angle 18) of the acoustic wave 12.

In one example, as mentioned before, the mappings 134 may be a reference table or lookup table that can be used to reference a particular ratio to the direction (e.g., angle 18) of the acoustic wave 12. Once a direction is determined, the instruction module 122 may then cause the processor(s) 110 to output the direction to the output device 140. The values relating the ratio to a particular angle or vice versa may have been previously determined in a controlled setting, wherein both the direction and ratios are known.

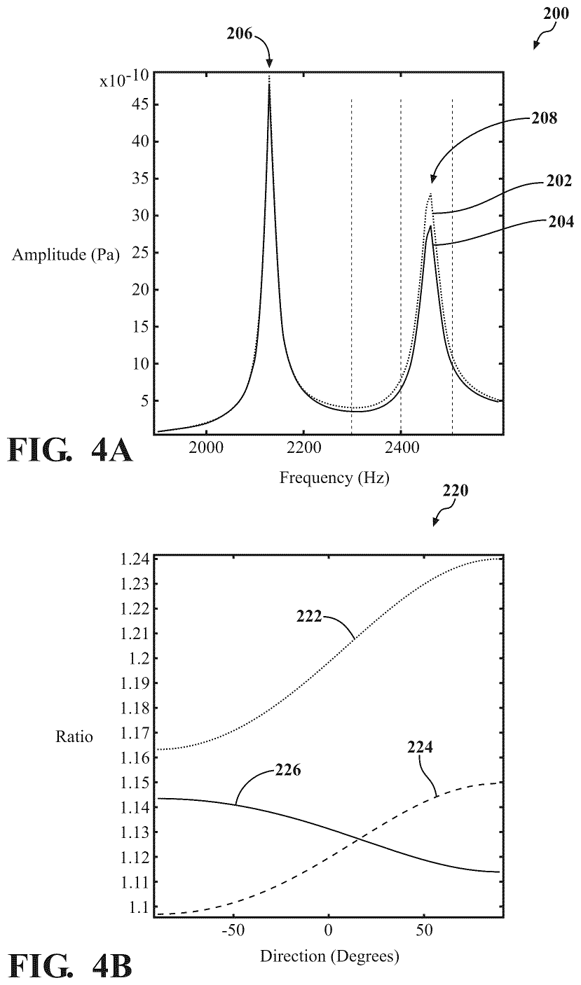

To better understand how a comparison (e.g., the ratio) of the amplitudes measured by the internal transducers 32A and 32B when sound is output by the speakers 24A and 24B, respectively, reference is made to FIGS. 4A and 4B, which relate to a system 10 that does not utilize the acoustic foam 50 within one of the resonant chambers 28A or 28B, such as shown in FIG. 2A.

In this example, FIG. 4A illustrates a chart 200 showing the measured amplitudes 202 and 204, over a range of different frequencies, determined by the internal transducers 32A and 32B when sound is output by the speakers 24A and 24B, respectively. As mentioned before, the speakers 24A and 24B may output sound when provided a signal from the external transducers 20A and 20B when the acoustic wave 12 is sensed. Additionally, it is noted that, in this example, the measured amplitudes 202 and 204 have peaks 206 and 208 at different frequencies.

FIG. 4B illustrates a chart 220 of the ratios 222, 224, and 226 (y-axis) of the measured amplitudes 202 and 204 at 2400 Hz, 2500 Hz, and 2300 Hz, respectively. It is noted that the ratios 222, 224, and 226 change as the direction (e.g., angle 18) (x-axis) of the acoustic wave 12 changes. Using the relationship of the ratios 222, 224, and/or 226 (y-axis) to the direction (x-axis), which may be represented in the mappings 134, the direction (e.g., angle 18) of the acoustic wave 12 can be determined.

In one straightforward example, the mappings 134 may be a lookup table with two columns. One column may indicate a ratio of the amplitudes measured by the internal transducers 32A and 32B when sound is output by the speakers 24A and 24B, respectively, at a certain frequency. The other column may indicate the direction in degrees of an acoustic wave detected by the external transducers 20A and 20B. As such, once the ratio is known, the lookup table can then be utilized to retrieve the direction of the acoustic wave 12.

As mentioned before, one of the resonant chambers 28A or 28B may utilize the acoustic foam 50, as best shown in FIG. 2B. The use of the acoustic foam 50 changes the acoustic amplitudes created when sound is output by the speakers 24A and 24B, respectively.

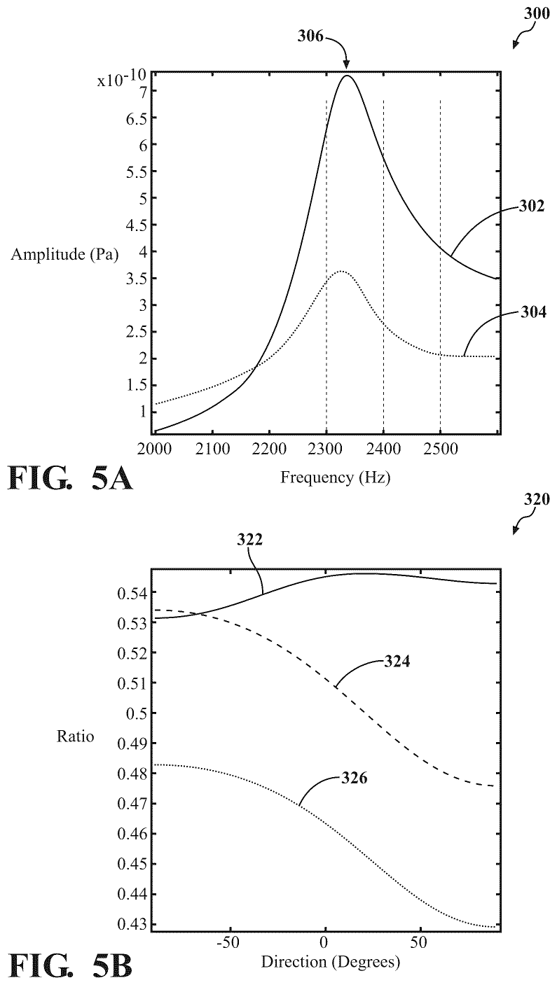

Moreover, FIG. 5A illustrates a chart 300 showing the measured amplitudes 302 and 304, over a range of different frequencies, determined by the internal transducers 32A and 32B when sound is output by the speakers 24A and 24B, respectively. In this example, due to the presence of the acoustic foam 50 in one of the resonant chambers 28A or 28B, the measured amplitudes 302 and 304 only include one peak 306, as opposed to multiple peaks 206 and 208. As such, the use of the acoustic foam 50 may be advantageous to cause a greater difference between the measured amplitudes 302 and 304.

As such, referring to FIG. 5B, like before, illustrates a chart 320 of the ratios 322, 324, and 326 (y-axis) of the measured amplitudes 302 and 304 at 2400 Hz, 2500 Hz, and 2300 Hz, respectively. Again, it is noted that the ratios 322, 324, and 326 change as the direction (e.g., angle 18) (x-axis) of the acoustic wave 12 changes. Using the relationship of the ratios 322, 324, and/or 326 (y-axis) to the direction (x-axis), which may be represented in the mappings 134, the direction (e.g., angle 18) of the acoustic wave 12 can be determined.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures. The embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A system comprising:
a first resonator having a first resonator chamber;
a second resonator having a second resonator chamber, wherein the first resonator chamber is fluidly connected to the second resonator chamber via a channel;
a first speaker connected to the first resonator chamber, the first speaker configured to output sound based on a signal produced from a first external transducer when detecting an acoustic wave;
a second speaker connected to the second resonator chamber, the second speaker configured to output sound based on a signal produced from a second external transducer when detecting the acoustic wave;
a first internal transducer configured to sense a first acoustic amplitude of a sound in the first resonator chamber produced by the first and second speakers; and
a second internal transducer configured to sense a second acoustic amplitude of a sound in the second resonator chamber produced by the first and second speakers.

2. The system of claim 1, further comprising a data acquisition system configured to determine a direction of the acoustic wave based on a comparison of the first acoustic amplitude and the second acoustic amplitude.

3. The system of claim 1, wherein the acoustic wave is acoustically separated from the first resonator chamber and the second resonator chamber.

4. The system of claim 1, further comprising an acoustic foam located in one of the first resonator chambers and the second resonator chamber.

5. The system of claim 1, wherein the first external transducer and the second external transducer are separated from each other by a known distance.

6. The system of claim 1, wherein the first resonator chamber has approximately the same volume as the second resonator chamber.

7. The system of claim 1, wherein the first resonator chamber has approximately the same dimensions as the second resonator chamber.

8. The system of claim 1, wherein a resonant frequency of the first resonator chamber is approximately the same as a resonant frequency of the second resonator chamber.

9. The system of claim 1, wherein the first resonator chamber and the second resonator chamber are cylindrical chambers, wherein the heights of the first and second resonator chambers are greater than the diameters of the first and second resonator chambers by a factor of at least 1.5.

10. A system comprising first and second resonator chambers fluidly connected via a channel, the first and second resonator chambers each having a speaker configured to output sound based on signals produced from external transducers when detecting an acoustic wave that is acoustically separated from the first and second resonator chambers.

11. The system of claim 10, further comprising a data acquisition system configured to determine a direction of the acoustic wave based on a comparison of a first acoustic amplitude sensed in the first resonator chamber and a second acoustic amplitude sensed in the second resonator chamber when the speakers output sound.

12. The system of claim 11, further comprising an internal transducer located within each of the first and second resonator chambers, wherein the internal transducer located within the first resonator chamber senses the first acoustic amplitude and the internal transducer located within the second resonator chamber senses the second acoustic amplitude.

13. The system of claim 10, wherein the external transducers include:
a first external transducer configured to output a signal to the speaker located within the first resonator chamber; and
a second external transducer configured to output a signal to the speaker located within the second resonator chamber.

14. The system of claim 13, wherein the first external transducer and the second external transducer are separated from each other by a known distance.

15. The system of claim 13, further comprising an amplifier for amplifying the signal from at least one of the first external transducer and the second external transducer.

16. The system of claim 10, further comprising an acoustic foam located in one of the first resonator chambers and the second resonator chamber.

17. The system of claim 10, wherein the first resonator chamber has approximately the same volume as the second resonator chamber.

18. The system of claim 10, wherein the first resonator chamber has approximately the same dimensions as the second resonator chamber.

19. The system of claim 10, wherein the first resonator chamber and the second resonator chamber are cylindrical chambers, wherein the heights of the first and second resonator chambers are greater than the diameters of the first and second resonator chambers by a factor of at least 1.5.

20. The system of claim 10, wherein a resonant frequency of the first resonator chamber is approximately the same as a resonant frequency of the second resonator chamber.
